(19) United States
(12) Patent Application Publication
(10) Pub. No.: US 2016/0125564 A1
(43) Pub. Date: May 5, 2016

(54) Compact Jury Trial

(71) Applicant: Anthony Jeremiah Bayne, Lomita, CA (US)

(72) Inventor: Anthony Jeremiah Bayne, Lomita, CA (US)

(21) Appl. No.: 14/529,126

(22) Filed: Oct. 30, 2014

(51) Int. Cl. G06Q 99/00

(52) U.S. Cl. CPC G06Q 99/00

(57) ABSTRACT

An article of manufacture and a method that enables a juror to hear a case's evidence remotely from a courthouse and/or other jurors. The evidence may be edited to exclude all matters that a judge rules are not to be considered by the juror. Additionally, the evidence may include things that are not “evidence” in the legal sense, including jury instructions. Further, the evidence may be close captioned using a licensed certified shorthand reporter's trial transcript.

### RELATED APPLICATIONS

None.

### BACKGROUND OF THE INVENTION

### Field of the Invention

The present application relates to condensing a case's evidentiary proceedings, and more particularly to an article of manufacture and method to enable a juror to hear a case's evidence in a compacted form while the juror is remote from other jurors.

A person charged with a criminal offense (i.e. a defendant) is entitled to a jury trial. People are summonsed for jury service to a nearby courthouse where the trial will be held. When a summonsed person becomes a “juror”, he or she will hear a case's evidence and deliberate with other jurors in an effort to reach a verdict, if possible. One or more alternate jurors (“alternates”) may additionally be to hear evidence, but they will only participate in jury deliberations if they are substituted in by a judge to replace a juror who has been excused.

Since jury trial hours (e.g. 8:30 AM to 4:30 PM) overlap with most juror's work hours (e.g. 9:00 AM to 5:00 PM), most jurors miss work while serving as a juror. Further, self-employed persons and employees of small businesses may not earn any income (excluding a jury stipend) while they serve as jurors. This loss of income may cause these jurors to suffer anxiety and prevent them from focusing on the case's evidence. A compromise verdict is a verdict that is reached after a juror gives up his view on a certain issue to avoid further deliberation or deadlock. Fear of not being able to pay bills may tempt a juror to enter into a compromise verdict, so that he can be excused from jury service and get back to work.

Further, some people summonsed to jury service fear going to a courthouse located in an economically depressed area (e.g. Compton, Calif.). Fear of being in a courthouse's parking lot after dark may also cause a juror to enter into a compromise verdict, so that they can leave the area before nightfall.

Additionally, while a courthouse can provide hearing devices for hearing impaired jurors, some jurors may not ask for such devices out of embarrassment, and so they may not hear some of what is being said by a testifying witness, or judge, etc.

Trials can be fluid, especially if there are many witnesses, defendant transportation issues, etc. During the evidentiary portion of a trial, last minute evidentiary proceedings, scheduling issues, and other calendar matters (other cases that the court handles) can lengthen the time it takes for a jury to hear the evidence. These matters are heard outside of the presence of jurors (e.g. while they wait in a courthouse hallway). Jurors view this as a waste of their time. For at least these reasons, people try to avoid jury service.

Another problem with jurors being present during the evidentiary portion of a jury trial is that jurors are exposed to things that a judge subsequently orders them to disregard as not being in evidence (e.g. The judge orders jurors not to consider a witness's answer that the judge strikes). This is similar to someone saying “Don't think about a pink elephant.”, and may be challenging for a juror (or anyone) to disregard. Yet another problem with jurors being present during the evidentiary portion of a jury trial is that jurors frequently speak a language (e.g. Spanish) that the juror testifies in. While jurors are ordered to only consider a certified interpreter's (court interpreter's) translation of what a witness is saying, a juror who thinks he understands the foreign language speaking witness may rely on his own understanding of what is said. This can be a problem during deliberations, because the juror is then not relying on the same evidence as the other jurors who only rely on the interpreter's translation.

A problem with jury deliberations is that jurors often asks the judge for “read back” of a witness's testimony. Read back takes place during courthouse hours and requires the court reporter who recorded a witnesses testimony, to “read back” a witness's testimony to the jury. Not being a witness or a partisan, the court reporter usually reads back the testimony with a poker face, in a monotone voice. Additionally, since the reporter has no idea whether or not a jury will request read back, and read back occurs during the deliberation period, the reporter has no time to separately edit what he/she is reading back, but instead must edit the record contemporaneously with the read back in front of the jury. This sometimes makes the read back halting, and difficult to follow. Further, this type of disembodied read back does not capture a testifying witness's demeanor. Since judges routinely instruct jurors that they may consider a witness's demeanor “while testifying” as a factor in determining whether a witness is credible, this halting, dead pan read back is a problem, because it omits a witness's demeanor. Further, read back uses a courthouse's resources (e.g. a courtroom and court personnel when a party chooses to be present when reads back occurs).

Therefore, a need exists to reduce the time it takes for a juror to hear a case's evidence, preserve the juror's ability to consider a witness's demeanor in determining a witness's credibility, and help court's reduce costs associated with conducting a jury trial.

### SUMMARY OF CERTAIN INVENTIVE ASPECTS

The present invention solves the above described problems and provides a distinct advance in the art of conducting a jury trial by changing the format of how evidence is heard by a juror, as well as expanding the time and location where it may be heard by the juror.

Since jurors are disallowed from discussing a case's evidence with one another until it is submitted to them for deliberation, there is no compelling reason for them to sit together in a courthouse to hear a case's evidence, as long as all jurors hear the same evidence before deliberating the case. As used herein, the phrase “hearing” evidence includes seeing evidence (e.g. exhibits).

Using certain embodiments of the invention described below, a jury may be selected by voir dire before the presentation of evidence, and then be allowed to leave the courthouse, as long as they swear/affirm to hear all the case's evidence before returning to court for jury deliberations, or participating in deliberations remotely.

Further, using certain embodiments of the invention, evidence may be edited before a juror hears it. A juror who hears an edited version of a trial's evidence will not be exposed to things that she is subsequently ordered by a judge to disregard (e.g. a stricken answer). Additionally, a juror who receives an edited version of the trial's evidence will not spend time waiting outside of a courtroom while the judge conducts evidentiary hearings or handles other calendar matters. Further, it will require less time for a juror to hear all the evidence, because the evidence will exclude things that typically occur during jury trials (e.g. sidebars) that the jurors can't consider, but see happen nonetheless.

Using certain embodiments of the invention described below, at least one juror will be able to hear evidence separately from other jurors, and/or remotely from the courthouse. A juror who hears evidence separately from other jurors have less opportunity to violate a judge's order not to discuss a case with another juror until the case is submitted to them for deliberation, as the remote juror will be out of other jurors' physical presence at least during the evidentiary portion of the trial.

Another benefit of allowing a juror to hear edited evidence remotely, is that a testifying witness (e.g. a victim of a sex offense) may feel less anxiety without a jury staring at them while testifying, and so may be able to recall detail more accurately. A defendant can be present while the witness testifies to preserve the defendant's right to confront and cross-examine the witness in open court. It is contemplated that the public will be allowed to attend the trial's proceedings.

Further, a juror who is able to review the evidence remotely, and/or participate in deliberations remotely (e.g. via Skype, WebEx Telepresence, GoToMeeting, etc.), will travel to a courthouse less while on jury service. This will result in less traffic, reduce air pollution, and reduce a court's expense for juror mileage reimbursement.

Using certain embodiments of the invention, the court reporter (e.g. a licensed certified shorthand reporter) who recorded a jury trial's evidentiary proceedings will be able to prepare and edit the transcript at a time other than during deliberations (i.e. when read back occurs). Further, the edited transcript can be used to create closed captioning for a video of the evidentiary proceedings that a juror can view remotely, at any time of the day. This will eliminate the need for a courtroom and courthouse personnel for read back. Also, this will allow persons who are hearing impaired to more easily participate as jurors, because they can max out the volume on any device they use (e.g. at home) to hear evidence with, without distracting another juror, and read the closed captioning as they watch the evidence (e.g. via streaming video). Further, evidence can be edited to mute a witness' foreign language testimony, so that only a certified interpreter's translation can be heard by a juror, guaranteeing that all jurors rely on the same testimony.

Also, when the evidence is recorded and edited before going to a jury, the jury may be selected before or after the evidentiary portion of a trial. Further, the recording of the trial proceedings can be taken at multiple angles to provide a split screen view showing the front of a witness, a judge and parties to a case. This is advantageous over a live trial, since jurors sit to the side of a courtroom and only see a witness testifying from a skewed angle. Providing a frontal view of a witness, will help a juror view a witness's demeanor more clearly to assess a witness's credibility.

In one embodiment, the invention provides for an article of manufacture, comprising a non-transitory machine-accessible medium having instructions encoded thereon for enabling a processor to perform the operation of communicating a case's evidence (e.g. via streaming video, DVD, etc.), wherein the evidence was recorded outside of the presence of at least one juror.

In another embodiment, the invention provides for a method for a judge to take a verdict, comprising the steps of communicating a trial's edited evidence via a non-transitory computer readable means to at least one juror, and receiving a verdict by a judge.

In another embodiment, the invention provides for a method for a juror to hear a case's evidence, comprising hearing a case's evidence by a juror, wherein the evidence is stored on a non-transitory computer readable medium.

Other aspects and advantages of the present invention will be apparent from the following detailed description of the preferred embodiments and the accompanying drawing figures.

### BRIEF DESCRIPTION OF THE DRAWINGS

The present application can be more fully understood by reading the following detailed description of the presently preferred embodiments together with the accompanying drawings, in which:

FIG. 1 illustrates an exemplary operating environment for a compact jury trial according to the exemplary embodiments of the present application.

FIG. 2 illustrates an exemplary flow diagram for judge to receive a jury verdict.

### DETAILED DESCRIPTION OF CERTAIN EMBODIMENTS

Exemplary embodiments of the present invention will hereinafter be described with reference to the figures, in which like numerals indicate like elements throughout the drawings.

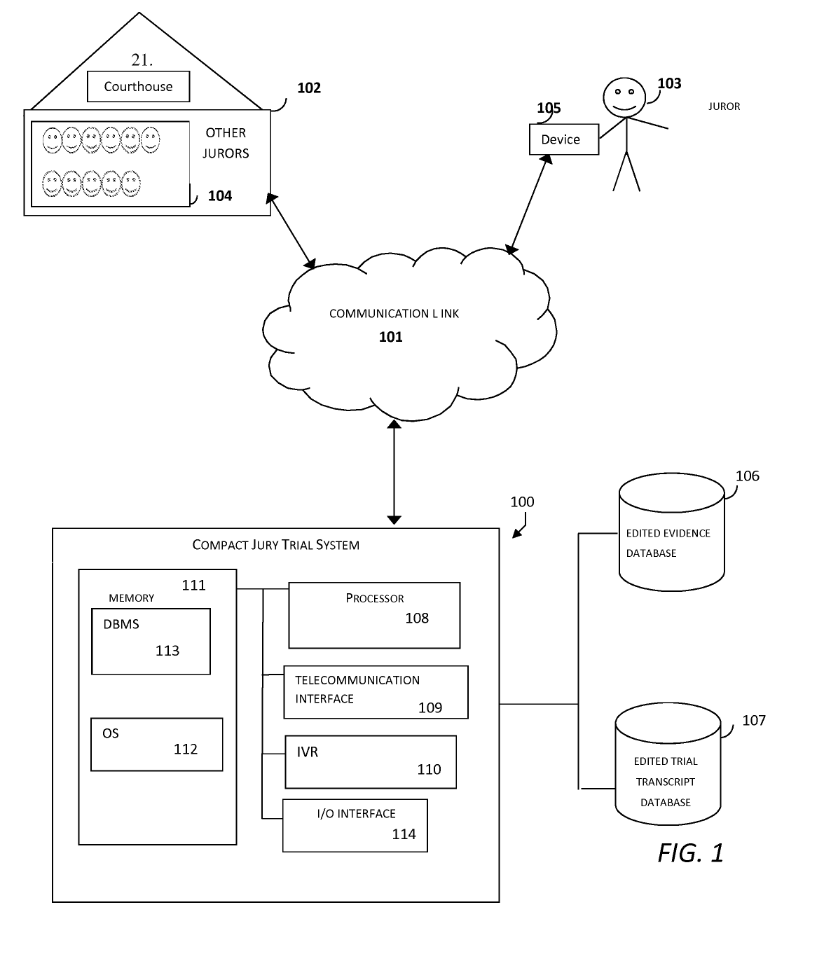

FIG. 1 is a block diagram illustrating an exemplary operating environment for implementation of certain embodiments of the present invention.

The exemplary operating environment includes a Compact Jury Trial System (CJTS) 100 that is in communication, via a communication link 101, with at least one courtroom of a courthouse 102 and at least one juror 103 that has been selected to hear a (criminal or civil) case's evidence. In an alternate embodiment, instead of or in addition to the courtroom of a courthouse 102, the CJTS 100 may be in communication with a system administrator that is not in the courthouse 102. In a preferred embodiment, the at least one juror 103 will use an electronic device 105 (e.g. a wireless tablet) that includes at least one video display and one speaker to hear the case's edited evidence remote from the courthouse 102. Alternatively, the device 105 will be used by the at least one juror 103 inside the courthouse 102. The device 105 may be issued by the courthouse 102, belong to the at least one juror 103, or issued by some other public or private entity. In yet another alternate embodiment, the device 105 may be a located in a courthouse 102 where deliberations are held (i.e. a jury room), so that more than one juror, or all jurors 103 & 104 for a case can hear the evidence simultaneously in the presence of one another.

The communication link 101 may be any public and/or private communication network. In certain embodiments, the communication link 101 is the Public Switched Telephone Network (PSTN). The communication link 101 may include wired and/or wireless segments, and may carry digital and/or analog signals. In alternate embodiments, the communication link 101 may take other forms, such as voice over IP network or other type of data network (e.g. the Internet). The various components and functionality of typical communication links, as well as proprietary communication networks, are well known in the art, and are therefore not described in detail herein.

The courthouse 102, or other public/private agent, may communicate a case's edited evidence, that is stored in an edited evidence database 106, to the at least one juror 103 who may be remote from other jurors 104, or at least one of them, via the communication link 101. As used herein, “communicate” includes making the case's edited evidence available for access by the at least one juror 103. Additionally, the edited evidence may include closed captioning that is based on an edited trial transcript that is stored in an edited trial transcript database 107. The edited evidence is stored on a non-transitory computer readable medium, and includes computer executable instructions and a video recording of a trial that was recorded outside the presence of at least one juror 103. In another embodiment, the evidence may include things that are not legally considered “evidence”, such as an opening statement, a closing argument, or a jury instruction.

The CJTS 100 is contemplated as being a processor driven device or collection of devices, that is configured for processing (e.g. receiving verification that the at least one juror 103 viewed the case's edited evidence in its entirety). The CJTS 100 may further be configured for accessing and reading associated computer readable media having stored thereon data and/or computer executable instructions for implementing the various methods of the present invention. In particular, the processor 108 provides the business logic for the CJTS 100 that supports and provides an environment for server side logic, expressed as objects, rules and computations, such as determining whether all jurors 103 & 104 have viewed the edited evidence in its entirety.

The CJTS 100 may have a telecommunications interface 109, including video conferencing, and/or an interactive voice response unit (IVR) 110, so that a judge (e.g. who presided over the trial) and/or jurors (103 & 104) may interact and input menu options.

The CJTS 100 memory 111 may take the form of any computable readable medium. The memory 111 may be logically and/or physically divided into multiple units. Memory 111 is not meant to be limited to any particular type of storage device or quantity of storage devices operating alone, or in combination. As will be appreciated by a person having ordinary skill in the art, memory 111 can store other data associated with a juror (103 & 104), case, or courthouse 102. The memory 111 stores data and program modules, such as, for example, an operating system (OS) 112, and a database management system (DBMS) 113.

The CJTS 100 may include, or be in communication with, one or more searchable databases. By way of illustration only, the CJTS 100 may be in communication with an edited evidence database 106 and an edited trial transcript database 107. These and/or other databases may also store any other data used or generated by the CJTS 100. Those skilled in the art will appreciate that the illustrated database may be physically and/or logically separate from one another.

The CJTS 100 may also include input/output (I/O) interfaces 114 for providing logical connections to various I/O devices, such as a touch screen, mouse, etc. A system administrator may utilize these and other I/O devices to interact with the CJTS 100. For example, a system administrator may interact with the CJTS 100 to populate and further modify the edited evidence database 106, and other program modules. Those skilled in the art will appreciate that the CJTS 100 may include alternate and/or additional components, hardware, or software.

Thus configured, or similarly configured, the CJTS 100 may provide a means for at least one juror 103 to hear evidence, and/or deliberate with other jurors 104, while the at least one juror 103 is remote from a courthouse 102, and/or other jurors 104.

While the invention will be discussed in terms of a juror 103 hearing “evidence” separately or remotely from other jurors 104, or at least one of them, evidence may include things that are not legally considered “evidence”, such as an argument by a party representative (e.g. a closing argument), and/or the reading of jury instructions by a judge.

As used herein the term “judge”, includes a magistrate, an arbitrator, a referee, and any other person or persons who preside over a case or controversy. Further, as used herein the term “juror” excludes a “mock juror”.

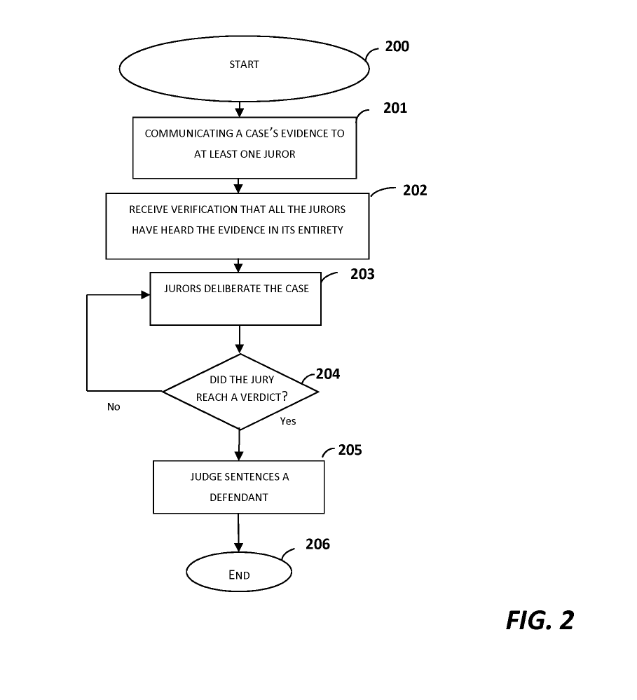

FIG. 2 illustrates an exemplary flow diagram for a judge to receive a jury verdict according to the exemplary embodiments of the present application. The method starts at step 200, and proceeds to step 201 where a case's evidence is communicated to at least one juror 103. In an alternate embodiment, the evidence may also be communicated to a party representative before being communicated to the at least one juror 103. In a preferred embodiment jurors 103 & 104 will hear the evidence in its entirety by a deadline set by the judge who presides over the case. The jurors may be selected before any evidence is presented, or after the evidence is presented.

In a preferred embodiment the evidence will be edited before going to the jury 103 & 104. In an alternate embodiment, the evidence will include all evidentiary proceedings that are usually conducted in front of a jury 103 & 104, including those things that the judge order's the jury 103 & 104 not to consider. In yet another alternate embodiment, the evidence will include things that are not “evidence” under the law, for example a video of a judge reading jury instructions, an opening statement, or a closing argument.

The method then proceeds to step 202 where a courthouse 102, including the judge who presided over the evidentiary portion of the case, receives verification that the jurors 103 & 104 have heard the case's evidence in its entirety.

In a preferred embodiment the jurors 103 & 104, and each of them, will have heard the evidence remotely from the courthouse 102 via an electronic device 105 provided by the courthouse 102. For example, a juror 103 may access a courthouse 102 website (not shown) using a courthouse 102 provided device 105 (e.g. a wireless tablet) and hear the evidence for the case that the juror 103 has been to hear. At the conclusion of hearing all the evidence remotely, the juror 103 may verify, under the penalty of perjury, that he has heard the evidence in its entirety.

Once all jurors 103 & 104 (and alternates, not shown) have heard the evidence, the method proceeds to step 203 where the jurors 103 & 104 deliberate the case. In a preferred embodiment, the jurors 103 & 104 will meet back at the courthouse 102 to deliberate in person. When the evidence did not include jury instructions, or at least one party's closing argument, those things can be done in the juror's 103 & 104 presence when they return to the courthouse 102 before deliberating. In an alternate embodiment, at least one juror 103 will deliberate remotely from the other jurors 104 via a communication link 101 (e.g. video conference).

The method proceeds to step 204 where it is determined whether or not the jury 103 & 104 has reached a verdict. If a verdict is not reached, the jurors 103 & 104 may be ordered by the judge to continue deliberations 203. However, if a verdict is reached, or if the jurors 103 & 104 are hopelessly deadlocked (e.g. the jurors 103 & 104 cannot reach a unanimous verdict in a criminal case, a “hung jury”), the method proceeds to step 205 where the judge takes the verdict (which includes the judge declaring a mistrial) and sentences/frees a defendant, dismisses a count/case, sets a retrial date, awards damages, etc. The method then proceeds to step 206 and ends.

As may be seen from the foregoing, the present invention provides a system, method and machine for conducting a compact jury trial. The invention provides convenience to jurors, saves money for courthouses, and provides a defendant due process of law. This invention may be especially useful if there is a pandemic where travel restrictions are in place, since jurors can hear evidence remotely from the courthouse and/or one another.

It should be appreciated that the exemplary aspects and features of the present invention as described above are not intended to be interpreted as required or essential elements of the invention, unless explicitly stated as such. It should also be appreciated that the foregoing description of exemplary embodiments was provided by way of illustration only and that many other modifications, features, embodiments and operating environments are possible. Accordingly, the scope of the present invention should be limited only the claims to follow.

I claim:

1. An article of manufacture, comprising
a non-transitory machine-accessible medium having instructions encoded thereon for enabling a processor to perform the operation of communicating a case's evidence, wherein the evidence was recorded outside of a juror's presence.

2. The article of manufacture of claim 1, wherein the instructions are further encoded for enabling a processor to perform the operation of allowing the evidence to be accessible during non-courthouse hours.

3. The article of manufacture of claim 1, wherein the instructions are further encoded for enabling a processor to perform the operation of allowing the evidence to be accessed via a device that is outside of a courthouse.

4. The article of manufacture of claim 1, wherein the instructions are further encoded for enabling a processor to perform the operation of providing a split screen viewing option.

5. The evidence of claim 1, further including a jury instruction.

6. The evidence of claim 1, further including closed captioning that is based on a licensed certified shorthand reporter's transcript of the case.

7. The evidence of claim 1, further including a court certified interpreter's voice instead of a testifying witness's voice for which the interpreter is translating.

8. The evidence of claim 1, wherein the evidence is edited to reflect a judge's evidentiary rulings on the case.

9. A method for a judge to take a jury verdict, comprising the steps of
making a trial's edited evidence accessible via a non-transitory computer readable means to at least one juror; and
receiving a jury verdict by a judge.

10. The method of claim 9, including the additional step of the juror accessing the evidence separately from another juror.

11. The method of claim 9, including the additional step of the juror deliberating remotely from a courthouse.

12. The method of claim 9, wherein the juror swears to hear all the evidence prior to participating in a jury deliberation.

13. The method of claim 9, wherein the verdict includes a mistrial.

14. A method for a juror to hear a case's evidence, comprising
hearing a case's evidence by a juror, wherein the evidence is stored on a non-transitory computer readable medium.

15. The method of claim 14, wherein the evidence has been edited to exclude a question that was objected to and the objection was sustained.

16. The method of claim 14, wherein the evidence includes a jury instruction.

17. The method of claim 14, wherein the juror's hearing of the evidence is done outside the presence of another juror.

18. The method of claim 14, wherein the juror's hearing of evidence is done outside of a courthouse.

19. The method of claim 14, wherein the juror deliberates with another juror via a communication link.

20. The method of claim 14, further including the step of a juror submitting verification that the juror has heard all the evidence before deliberations.
